(19) United States
(12) Patent Application Publication
(10) Pub. No.: US 2004/0120414 A1
(43) Pub. Date: Jun. 24, 2004

(54) Method and apparatus for reducing peak to average power ratio in QAM multi-channel blocks

(76) Inventors: Gerald Harron, Martensville (CA); Douglas Fast, Warman (CA); Surinder Kumar, Victoria (CA)

Correspondence Address: ADE & COMPANY, 1700-360 MAIN STREET, WINNIPEG, MB, R3C3Z3, CA

(21) Appl. No.: 10/671,873

(22) Filed: Sep. 29, 2003

Related U.S. Application Data
(60) Provisional application No. 60/414,394, filed on Sep. 30, 2002.

(51) Int. Cl. H04L 5/12; H04L 23/02

(52) U.S. Cl. 375/261

(57) ABSTRACT

The present inventions provide methods and systems for reducing the peak to average power ratio of a multi-channel block of QAM signals. Reducing the peak to average power ratio of a signal ensures that amplifiers and transmitters are not saturated, causing loss of data, and reducing spatter to adjacent channels. Further, reducing peak to average power ratios reduces the consumption of power during transmission. The reduction is obtained by providing a symbol delay on one or more of the QAM signals prior to the signals being summed where the delay is computed such that peak QAM power transitions in the QAM signals statistically do not align in time. The delay is arranged according to the equation: the additional delay for each QAM signal is equal to the symbol rate of the QAM signals divided by the number of QAM signals in summation.

### FIELD OF THE INVENTION

This application claims priority under 35 U.S.C.119 from U.S. Provisional Application Serial No. 60/414,394 filed Sep. 30, 2002.

This invention relates generally to communication systems. The present invention relates more specifically to reducing peak to average power ratios in a block of two or more QAM channels in a communications system.

### BACKGROUND OF THE INVENTION

In digital communication technology today, one of the more common methods of packing more data bits within an allocated bandwidth is performed using multilevel systems or M-ary techniques. Since digital transmission is notoriously wasteful of RF bandwidth, regulatory authorities usually require a minimum bit packing. One of the more common techniques combining both amplitude and phase modulation is known as M-ary quadrature amplitude modulation (QAM). QAM modulates two different signals into the same bandwidth. This is accomplished by creating a composite amplitude modulated signal using two carriers of the same frequency. The two carriers are distinguished by having a phase difference of 90 degrees. By convention, the cosine carrier is called the in-phase component and the sine carrier is the quadrature component.

One example of a prior art QAM modulator is described hereinafter in conjunction with the Figures.

In U.S. Pat. No. 6,512,797 issued Jan. 28, 2003 by Tellado et al “Peak to average power ratio reduction” is described an arrangement which uses the addition of a signal to sum in as a peak reduction signal at the time of the peak.

In U.S. Pat. No. 6,424,681 issued Jul. 23, 2002 by Tellado et al “Peak to average power ratio reduction” is described an arrangement which references peak to average reduction in a multi carrier system but uses a “kernel” to negate or subtract one or more peaks.

In U.S. Pat. No. 6,597,746 issued Jul. 22, 2003 by Amrany et al “System and method for peak to average power ratio reduction” is described an arrangement which uses a method of reducing the peak before the DAC, hence is a form of pre-distortion. This construction does not apply to a multi carrier.

A problem in the design of linear power amplifiers is the effect of the transmitted signal's peak-to-average ratio on performance. As the peak-to-average ratio (PAR) increases, the back-off needed for adequate splatter performance of the power amplifier increases proportionally. Splatter, which is signal energy that extends beyond the frequency band allocated to a signal, is highly undesirable because it interferes with communications on adjacent channels. Furthermore, when multiple signals are combined prior to amplification, the PAR of the sum is very often higher than that for the single channel. This requires amplifier back-off greater than that already mentioned. Therefore, it is highly desirable to control the PAR of the signal input to the amplifier. However, any attempt to reduce the nominal PAR through other than linear processing functions (i.e., non-linear signal processing) generates splatter.

Reducing the peak to average power ratio of a signal requires that the umber and magnitude of the peaks are reduced. There are a number of echniques commonly used to accomplish this goal.

One method of reducing PAR is hard clipping, which reduces each signal value exceeding a clip threshold to a predetermined magnitude, often the threshold magnitude. Hard-clipping causes significant splatter due to the abrupt nature of its operation.

Another method of reducing PAR is a “soft” algorithm that applies the desired signal to a non-linear device that limits signal peaks. A significant proportion of the input samples must be altered, causing significant energy to be splattered into adjacent channels.

A third method randomly shuffles the phase of the signals at each carrier frequency f(1)-f(n). Random shuffling does not completely eliminate the problem, although randomizing has been shown to reduce the peak to average power ratio. In addition to not completely reducing the peak to average power ratio to a practical point, that particular method also requires that additional information, side information, be sent along with the transmitted signal. In order for the receiver to be able to decode the transmitted signal the receiver must also know how the signals 10(1)-10(n) were randomized. Thus, the randomization scheme requires extra bandwidth to transmit the side information and does not effectively reduce the peak to average power ratio.

Another method has been applied to multi-carrier communication systems that use a small number of carrier frequencies. In that method all the different possible outputs of each signal 10(1)-10(n) are simulated. For example, if each signal 10(1)-(n) is a 4-ary quadrature amplitude modulated signal, each signal would be one of four different waveforms. If there are ten carrier frequencies, then over a million combinations are simulated. Those combinations of the outputs of signals 10(1)-(n) that exhibit peak to power ratios that exceed a specified limit are not used in actual transmissions. Typically, a channel must be simulated periodically because of changes in the channel's characteristics.

The elimination of some of the possible combinations of the outputs of the signals, however, reduces the bandwidth of the communication scheme. Further, the method can only be applied to communication systems that use a few carriers since the number of simulations required increases exponentially with an increase in the number of carriers. That is, if M-ary QAM and N frequencies are used, N.sup.M combinations must be simulated. M can be as high as 1024 and N even larger. Thus, this method becomes impractical when even a moderate number of carriers are used.

What is desired is a method of reducing the peak to average power ratio of a transmission within a block of QAM channels. A method without a significant decrease in the amount of usable bandwidth, and with low complexity such that reduction of the peak to average power ratio may be performed in real time, is also desirable.

### SUMMARY

According to the present invention there is provided a method of generating a multi carrier quadrature amplitude modulation (QAM) signal comprising:

creating a plurality of composite amplitude modulated QAM signals each using two carriers of the same frequency wherein the two carriers are distinguished by having a phase difference of 90 degrees;

wherein the QAM signals are of the same modulation;

wherein the QAM signals have symbol clocks which are of the same data rate and locked in phase;

summing the QAM signals to form a composite multi carrier QAM signal;

and amplifying the signal in a power amplifier for transmission;

wherein there is provided a symbol delay on one or more QAM signals prior to the signals being summed where the delay is computed such that peak QAM power transitions in the QAM signals statistically do not align in time.

Preferably the delay is arranged according to the equation: the additional delay for each QAM signal is equal to the symbol rate of the QAM signals divided by the number of QAM signals in summation.

Preferably the delay is performed at any point the modulation process of the QAM signal.

Preferably the delay is performed immediately prior to summation of the QAM signals.

However the delay can be performed in the RF stage of the composite QAM signal transmission.

Preferably the carriers of the QAM signals are of equal level.

The present invention provides a simple method for reducing the PAR in a QAM modulated channel block. Several objects and advantages which may be provided by the present invention are:

1. To provide a method of PAR reduction which is low complexity and able to operate in real time.

2. To provide a method of PAR reduction which is linear and does not result in undesirable signal splatter across the frequency band.

3. To provide a method of PAR reduction that does not require any associated processing in the receiver/demodulator.

4. To provide a method of PAR reduction which does not require extra pilot signals or additional filtering in the transmitter.

5. To provide a method of PAR reduction that does not require any additional channel bandwidth over and above that which is normally required for transmission.

6. To provide a method of PAR reduction which does not reduce the channel band width below that which is normally available for transmission.

### BRIEF DESCRIPTION OF THE DRAWING

One embodiment of the invention will now be described in conjunction with the accompanying drawings in which:

FIG. 1 is a schematic block diagram of a Prior Art QAM Modulator.

FIG. 2 is a schematic block diagram of a Prior art system for Construction of a Two Channel Composite QAM Signal

FIG. 3 is a Constellation Plot for a 4-level two channel composite QAM Signal.

FIG. 4 is a schematic block diagram of a system for Construction of Modified Two Channel Composite QAM Signal according to the present invention.

FIG. 4A illustrates the delay concept in block diagram format.

FIG. 5 is a Constellation Plot for a 4-level two channel composite QAM Signal according to the present invention.

FIG. 6 is a Constellation Plot for a Modified Two Channel Composite QAM Signal.

FIG. 7 is a Constellation Plot for a conventional Four Channel Composite QAM Signal.

FIG. 8 is Constellation Plot for a Modified Four Channel Composite QAM Signal.

FIG. 9 is an Eye Diagram in the time domain, of a QPSK baseband signal

FIG. 10 is an Eye Diagram of 2 QPSK signals overlapped in the time domain.

FIG. 11 is an Eye Diagram of 4 QPSK signals overlapped in the time domain.

### DETAILED DESCRIPTION

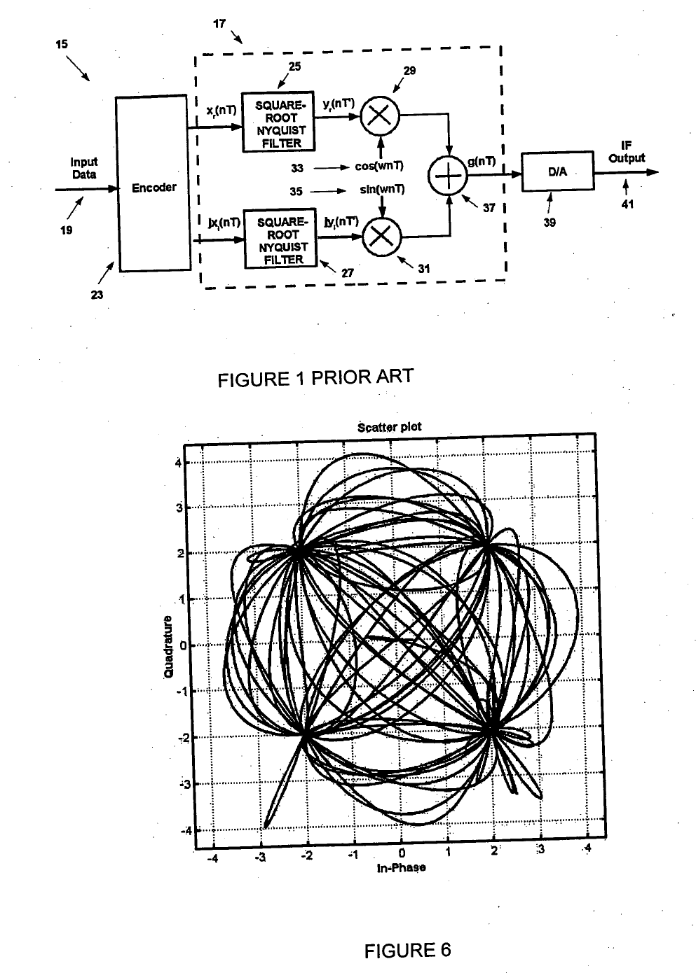

A prior art, all digital architecture 15 for a QAM modulator 17 is shown in FIG. 1. The modulator 17 accepts a digital input 19 for input to an encoder 23. The encoder 23 divides the incoming signal into a symbol constellation corresponding to in-phase (I) (xᵣ(nT)) and quadrature (Q) (jxᵢ(nT)) phase components while also performing forward error correction (FEC) for later decoding when the signal is demodulated. The converter outputs are coupled to a QAM modulator 17 comprising identical finite impulse response (FIR) square-root raised Nyquist matched filters 25, 27. The Nyquist filters 25, 27 are a pair of identical interpolating low-pass filters which receive the I (xᵣ(nT)) and Q (jxᵢ(nT)) signals from the encoder 23 and generate real and imaginary parts of the complex band-limited base band signal. The Nyquist filters 25, 27 ameliorate intersymbol interference (ISI) which is a by-product of the amplitude modulation with limited bandwidth. After filtering, the in-phase ((yᵣ(nT′))) and quadrature (yᵢ(nT′)) components are modulated with mixers 29, 31 with the IF center frequencies 33, 35 and then summed 37 producing a band limited IF QAM output signal (g(nT)) for conversion 39 to analogue 41. The analogue signal is then through a linear power amplifier and transmitted over the communications system. It is also possible to sum the output signals from multiple QAM modulators together and pass the resulting composite signal through the linear power amplifier. This has the advantage of reducing the number of linear power amplifiers required, as well as reducing the overall power consumption of the system.

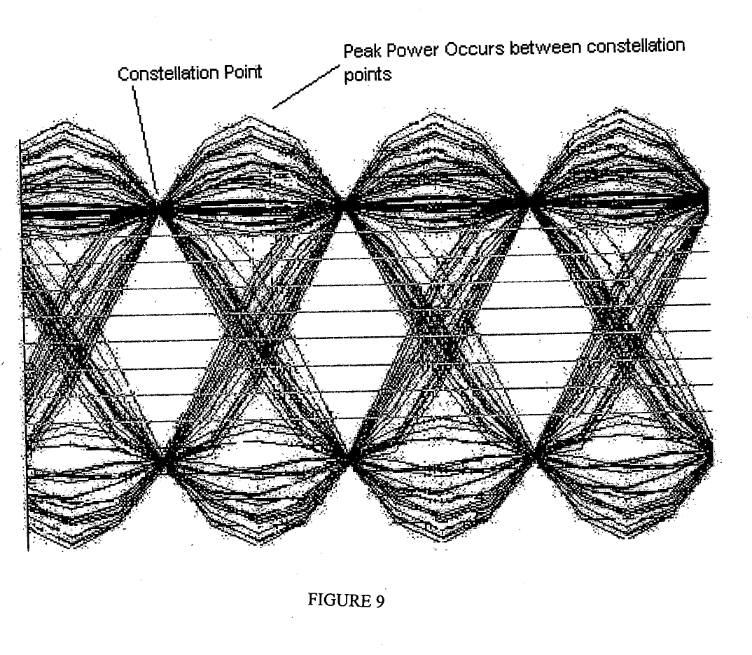

The output of a QAM modulator can be illustrated using a constellation diagram. The constellation diagram for 4-ary QAM (QPSK) modulation is shown in FIG. 3. This highest peak power point will typically occur at the half way time point in travelling between the symbols. The peak power point approaches the half way point closer as the peak power goes higher. This is due to SRRC filtering. This effect can also be visualized in the time domain with a eye diagram. FIG. 9 which is an Eye Diagram of the 4-ary QAM illustrates the time domain of the constellation. Note that the peak power occurs between the constellation points. 4-ary QAM (QPSK) is shown but the peak power concept applies to any level of QAM modulation. The input data is represented by the 4 constellation points. The paths between the points are the result of SRRC filtering. Each path takes the same amount of time to traverse, even though their physical lengths vary. The peak power of the QAM signal occurs at the point in the constellation that is farthest from the center.

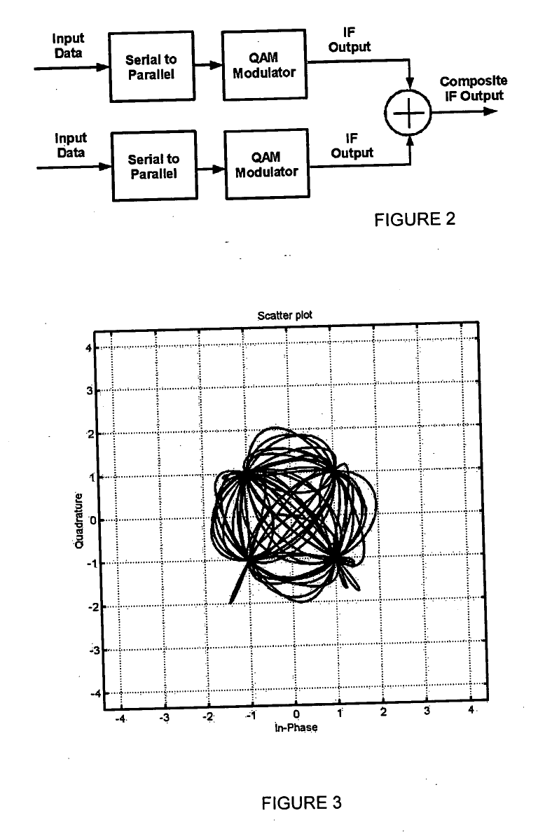

It is common for many of the QAM modulators used in cable television systems to have identical symbol rates and constellation sizes, especially in VOD (video on demand) systems. Furthermore, it is also common for several QAM signals to be generated within the same CATV head end facility, or even within the same equipment rack. For reasons of efficiency, it is desirable to combine several QAM signals prior to power amplification. FIG. 2 illustrates one method of combining two QAM signals to produce a single composite signal. As was already mentioned, the composite signal has a higher PAR than the individual signals. The line amplifiers of a CATV system are also subject to the peak to average ratio, as they must pass the combined CATV spectrum of QAM channels. Hence any reduction of the peak to average ratio of the combined RF QAM signals is also a benefit for performance of the CATV system, as the line amplifiers will not be exposed to as high of peak to average ratios and the spatter will be reduced.

FIG. 1 shows an impulse generator immediately before the QAM modulator. If the outputs of the two impulse generators used inside the QAM modulators in FIG. 2 are time aligned such that they each generate an impulse at the same time instant, then the two QAM signals will also be synchronized. This means that both QAM signals will pass through a constellation points at the same instant in time.

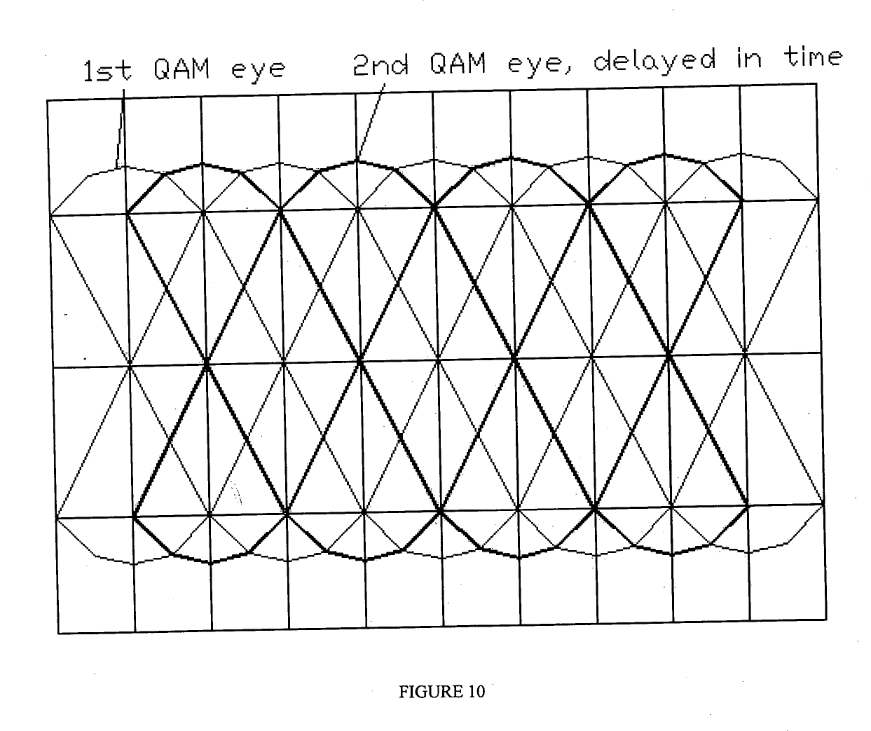

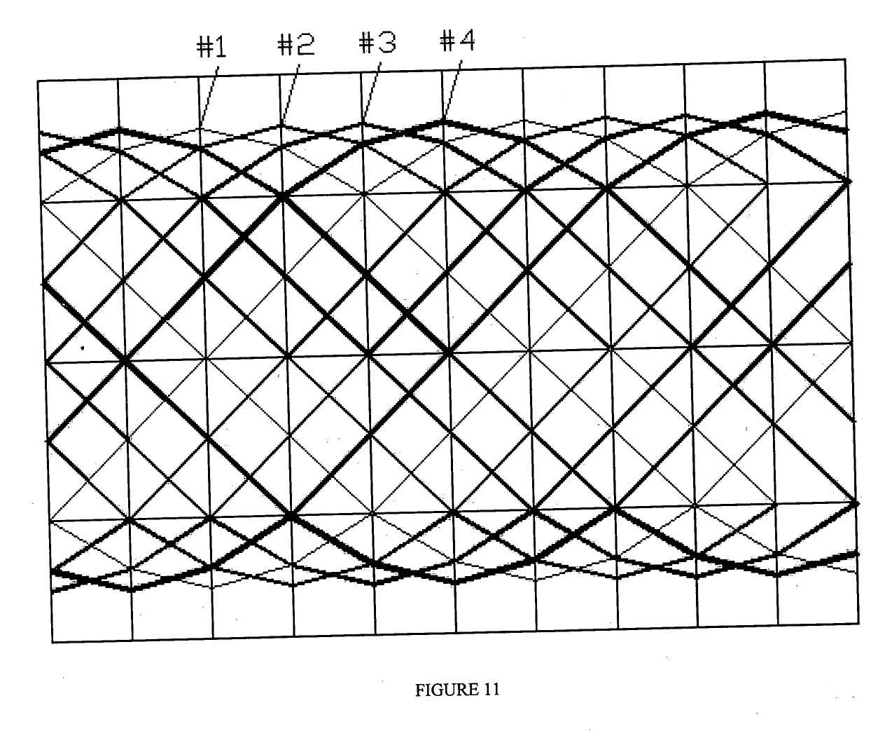

The two QAM signals will then add either constructively or destructively. The peak power of the composite signal will correspond to the point at which the sum is maximum. The worst case peak power will happen when both QAM modulators traverse the path farthest from the center of the constellation at the same time. In this case, the peak power will be two times the single channel peak power. FIG. 5 shows the constellation plot for a two channel composite QAM signal. This is also illustrated in the time domain in FIG. 10 which is an Eye Diagram of two 4-ary QAM signals combined, where if 2 eye diagrams have the same constellation point then the peaks of the transitions will align in time, and statistically produce a higher peak. FIG. 10 shows them staggered in time by ½ symbol time. As can be seen by the time domain the extreme peaks no longer line up in time. This reduces the peak power.

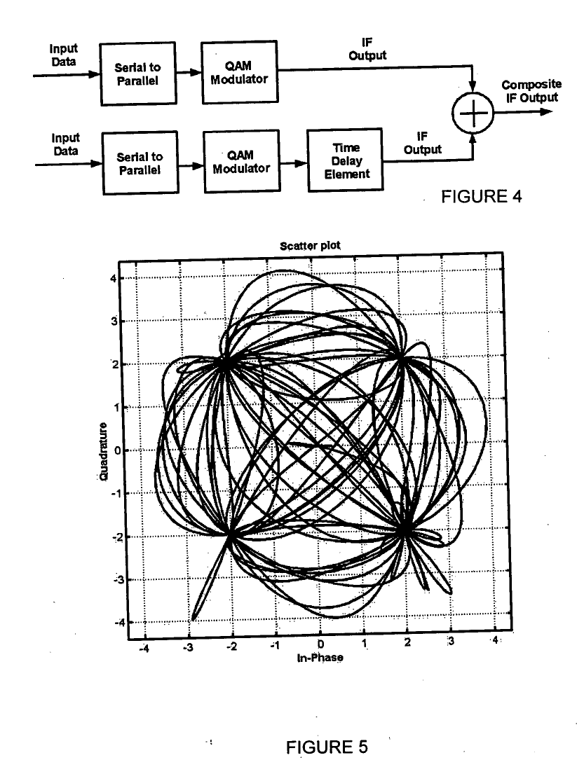

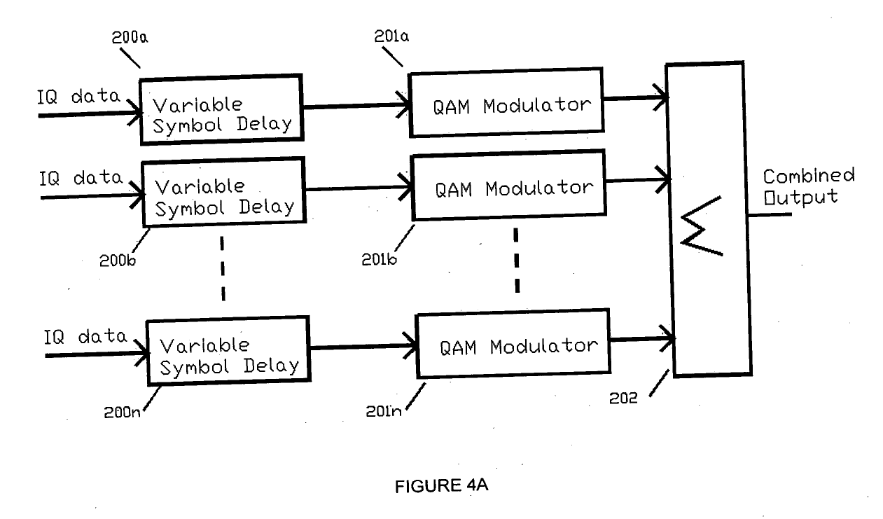

FIG. 4 illustrates the apparatus according to the present invention. The present invention adds a delay line following the second QAM modulator and before the summation of the two channels. By simple extension, it is possible to use appropriate delay lines to combine more than two QAM channels. If the delay through the delay element is set equal to half of the time distance between two constellation points, this will guarantee that the two QAM signals will never reach a peak at the same time. The two QAM signals will never traverse the same path at the same time, and the peak power will therefore be reduced.

FIG. 4A illustrates the delay concept in block diagram format. Each QAM signal is delayed by a delay period in a delay component 200A to 200N, where the delay, in this preferred implementation, is applied at the baseband. Each QAM is delayed by a different period according to the equation: the additional delay period for each QAM signal is equal to the symbol rate of the QAM signals divided by the number of QAM signals in summation. This would stagger the delay period for the first signal in delay component 200A to be different from 200B, extendable to 200N. The output of the QAM modulators 201A to 210N are combined. When combined the peak to average ratio is reduced due to the peak values not aligning in time.

FIG. 6 shows the constellation plot for a two channel composite QAM signal according to the present invention. It is evident that the peak power has been reduced through the use of the delay line. FIG. 10 is an Eye Diagram showing two, 4-ary QAM signals in the time domain. It is visible from the time domain that the peaks are staggered and that the peak power is not adding up to as high as level as when the symbols of QAMs are aligned. The staggering is this case is every ½ symbol.

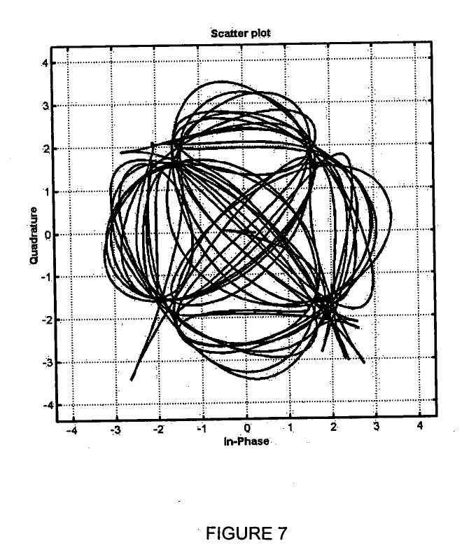

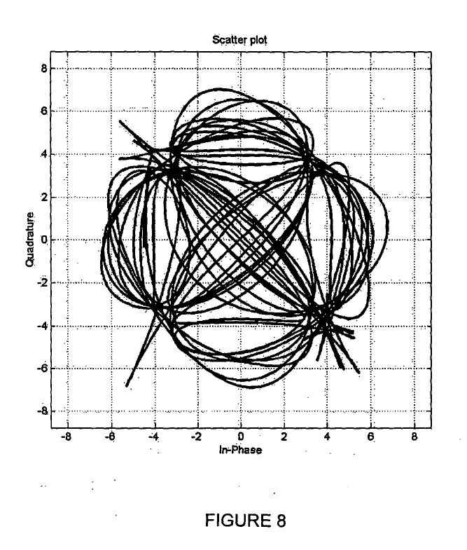

FIG. 7 shows the constellation plot for a conventional four channel composite QAM signal. FIG. 8 shows the constellation plot for a four channel composite QAM signal according to the present invention. It is evident that the peak power has been reduced through the use of the delay line. FIG. 11 which is Eye Diagram with four 4-ary QAM channels in the time domain, arranged so the transition peaks do not add as significantly as when they each could statistically be at the highest peak. In this case FIG. 11 shows the staggering is every 1/4 symbol. Highest efficiency is obtained when the delay is arrange according to the following equation: additional delay for each QAM is equal to the symbol rate divided by the number of QAMs in the block.

The arrangement described herein has the following features of advantage:

1. Low complexity, without modification of symbols, or individual QAM channel levels, or the addition of any other signal or pilot.

2. Fully compatible with demods/decoders since the modulation of individual QAM channels is not altered in any way.

3. Compatible with any number of QAMs in a block from 2 to N.

4. Compatible with any level of QAM modulation, from QPSK to 1024 QAM

1. A method of generating a multi carrier quadrature amplitude modulation (QAM) signal comprising:
creating a plurality of composite amplitude modulated QAM signals each using two carriers of the same frequency wherein the two carriers are distinguished by having a phase difference of 90 degrees;
wherein the QAM signals are of the same modulation;
wherein the QAM signals have symbol clocks which are of the same data rate and locked in phase;
summing the QAM signals to form a composite multi carrier QAM signal;
and amplifying the signal in a power amplifier for transmission;
wherein there is provided a symbol delay on one or more QAM signals prior to the signals being summed where the delay is computed such that peak QAM power transitions in the QAM signals statistically do not align in time.

2. The method according to claim 1 wherein the delay is arranged according to the equation: the additional delay for each QAM signal is equal to the symbol rate of the QAM signals divided by the number of QAM signals in summation.

3. The method according to claim 1 wherein the delay in is performed at any point the modulation process of the QAM signal.

4. The method according to claim 1 wherein the delay in is performed immediately prior to summation of the QAM signals.

5. The method according to claim 1 wherein the delay in is performed in the RF stage of the composite QAM signal transmission.

6. The method according to claim 1 wherein the carriers of the QAM signals are of equal level.
